(19) United States
(12) Patent Application Publication
(10) Pub. No.: US 2026/0202029 A1
(43) Pub. Date: Jul. 16, 2026

(54) PRINTED MATTER MANUFACTURING METHOD

(71) Applicant: Shuhou Co., Ltd., Fukui-shi (JP)

(72) Inventor: Kouji MURAOKA, Sabae-shi (JP)

(73) Assignee: Shuhou Co., Ltd., Fukui-shi (JP)

(21) Appl. No.: 19/564,774

(22) Filed: Mar. 12, 2026

Related U.S. Application Data
(62) Division of application No. 18/556,726, filed on Feb. 6, 2023, now abandoned.

(51) Int. Cl. F21S 41/20; B41F 17/00; B41M 1/40; B41M 3/00

(52) U.S. Cl. CPC F21S 41/2805; B41F 17/001; B41F 17/006; B41M 1/40; B41M 3/008

(57) ABSTRACT

A printed matter manufacturing method of manufacturing printed matter, the printed matter including a base body made of a material that allows transmission of light, a visible surface of the base body having a three-dimensional surface structure having a depth, the method comprising pushing a printing surface of a printing pad against a printing original plate on which ink is placed, moving the printing pad, in which the ink is transferred to the printing surface, to an area above the base body, and pushing the printing surface of the printing pad against at least one surface of the base body to cause the printing surface to deform in such a way as to conform to the three-dimensional surface structure, to transfer the ink placed on the printing surface of the printing pad to the one surface, thus forming a print image region to which the ink is transferred.

The present application is a Divisional of U.S. Application No. 18/556,726 filed October 23, 2023, which is the U.S. National Stage of PCT Application No. PCT/JP2023/003692 filed February 6, 2023, the entire content of each of which is incorporated by reference herein.

### TECHNICAL FIELD

The present disclosure relates to a printed matter manufacturing method in which printing is performed on a base body that allows transmission of light to form a printed matter.

### BACKGROUND ART

Conventionally, as decorative components of automobiles, there have been known decorative molded products, such as headlights, tail lamps, or backlight components of automobiles, each of which includes at least one base body and a cover layer, the visible surface of the base body having a three-dimensional surface structure having a depth, the base body being made of an injection-molded thermoplastic resin, the cover layer covering at least the visible surface and being made of a transparent resin, the decorative molded product being characterized in that the visible surface of the base body includes at least one layer, the layer contains flaky effect pigment, the flaky effect pigment extends in the direction substantially parallel to the surface of the visible surface of the base body, and a resin that forms the base body contains flaky effect pigment (see Patent Literature 1, for example). Therefore, it is possible to obtain a decorative formed product that allows an effect pigment to be visually perceived through a transparent resin of the decorative molded product and that has sense of depth and luxurious appearance.

As a vehicle display device, there is a known "vehicle display device including a transmitted illumination dial and an A/T finisher, the transmitted illumination dial being provided with characters, graduation, and the like displaying indicated values of meters, such as a speedometer, an engine tachometer, a fuel meter, and a thermometer, the A/T finisher being provided with an indicator display mark, the indicator display mark being displayed by reflection of propagation light, wherein the transmitted illumination dial being provided with a printing layer for patterning an illumination control display mark for transmitted illumination, formed thereon simultaneously with formation of a printing layer for patterning the characters, the graduation, and the like; portions of the A/T finisher other than the portion at which the indicator display mark is provided are caused to overlap with the rear surface of the transmitted illumination dial at a position that corresponds to a portion at which the illumination control display mark is provided, and the illumination control display mark provided to the transmitted illumination dial is transmissively illuminated with reflected light that propagates through the A/T finisher" (see Patent Literature 2, for example).

### Citation List

### Patent Literature

Patent Literature 1: Japanese Unexamined Patent Application Publication No. 2015-514603

Patent Literature 2: Japanese Unexamined Patent Application Publication No. 2019-086378

### SUMMARY OF INVENTION

### Technical Problem

However, according to Patent Literature 1, a decorative formed product is produced by performing "a step of forming a three-dimensional surface structure having a depth on a predetermined visible surface by forming a base body made of a thermoplastic resin in a mold by injection molding, a step of applying coating effect paint of a color that corresponds to the thermoplastic resin, the effect paint containing flaky effect pigment extending in the direction substantially parallel to the surface of the visible surface of the base body, a step of drying an effect paint layer, and a step of inserting the base body, to which the effect paint is applied by coating, into a flooding die, of applying a transparent resin to at least the visible surface of the effect pigment to form a cover layer, and of curing the cover layer". In other words, molding in which effect pigment is covered by a transparent resin is performed by injection molding or injection compression molding. That is, in obtaining the decorative formed product disclosed in Patent Literature 1, there is a problem that it is necessary to perform molding a plurality of times, so that the number of steps is increased.

Patent Literature 2 discloses the vehicle display device configured as follows. "The design forming region of the dial is formed such that a base that is made of a polycarbonate sheet of light transmissive material allowing transmission and diffusion of light with a wavelength at least within a visible light range, that is, of visible light, for example is subjected to printing with black ink with a shape that corresponds to a design pattern being blanked. The light blocking region on the dial is a region that blocks visible light emitted from respective visible-light light sources." Printing is performed to block light. However, the printing is performed on the sheet-like base and, to control the amount of light transmission through a three-dimensional structure, it is necessary to deform the sheet-like base in such a way as to conform to the three-dimensional structure. Accordingly, there is a problem that the number of steps is increased.

The present disclosure has been made to solve the above-mentioned problems, and it is an object of the present disclosure to obtain a printed matter that can reduce the number of steps, that can be used as a decorative component, a display device, or lighting equipment, that is made of a material allowing transmission of light, and that has a three-dimensional surface structure having a depth on a visible surface, and to obtain a printed matter manufacturing method, and to obtain lighting equipment.

### Solution to Problem

A printed matter according to an embodiment of the present disclosure is a printed matter formed by pushing a printing surface of a printing pad to transfer ink placed on the printing surface, the printed matter including: a base body made of a material that allows transmission of light, a visible surface of the base body having a three-dimensional surface structure having a depth; a print image region provided on at least one surface of the base body, the print image region being a region in which ink is placed; and a non-printing region provided on the one surface, the non-printing region being a region in which no ink is placed, wherein the print image region is provided in an area including the three-dimensional surface structure formed on the one surface, and the print image region has a smaller amount of light transmitted than the non-printing region.

A printed matter manufacturing method according to another embodiment of the present disclosure is a method for manufacturing the above-mentioned printed matter, the method including a printing process in which the printing pad is pushed against at least the one surface of the base body to transfer the ink placed on the printing surface of the printing pad to the one surface, thus forming, at least at a portion of the one surface, the print image region to which the ink is transferred, wherein the printing process includes pushing the printing surface against a printing original plate on which the ink is placed, moving the printing pad, in which the ink is transferred to the printing surface, to an area above the base body, and pushing the printing surface of the printing pad to cause the printing surface to deform in such a way as to conform to the three-dimensional surface structure.

Lighting equipment according to still another embodiment of the present disclosure is lighting equipment including: a reflection surface configured to reflect light; a light source configured to emit light; and an illumination cover configured to cover the reflection surface and the light source, wherein the illumination cover is formed by the above-mentioned printed matter, and is disposed with the one surface directed toward the light source and the reflection surface.

### Advantageous Effects of Invention

According to the embodiment of the present disclosure, the printing region is formed on one surface of the base body, so that it is possible to obtain a printed matter in which the other surface that faces the one surface forms an external appearance, and the printed matter can be used as a decorative component, the display portion of a display device, or a cover of lighting equipment, for example.

### BRIEF DESCRIPTION OF DRAWINGS

FIG. 1 is a diagram illustrating a cross-sectional structure of a printed matter 70 according to Embodiment 1.

FIG. 2 is an enlarged view showing one example of a portion A shown in FIG. 1.

FIG. 3 is an enlarged view showing one example of the portion A shown in FIG. 1.

FIG. 4 is a plan view showing one example of one surface 70a of the printed matter 70 shown in FIG. 1.

FIG. 5 is a side view showing one example of a pri apparatus 100 according to Embodiment 1.

FIG. 6 is a cross-sectional view showing one example of a printing pad 10 included in the printing apparatus 100 according to Embodiment 1.

FIG. 7 is a cross-sectional view showing a state in which the printing pad 10 included in the printing apparatus 100 according to Embodiment 1 is pushed against a printed matter 70.

FIG. 8 shows a flow of a printed matter manufacturing method with the printing apparatus 100 according to Embodiment 1.

FIG. 9 shows a flow of an action of the printing apparatus 100 according to Embodiment 1.

FIG. 10 shows a modification of the printing pad 10 used in the printing apparatus 100 of Embodiment 1.

FIG. 11 is a schematic view showing a case where the printed matter 70 according to Embodiment 1 is used for lighting equipment 90.

FIG. 12 shows a modification of the printed matter 70 shown in FIG. 11.

FIG. 13 shows a modification of the printed matter 70 shown in FIG. 11.

FIG. 14 shows a modification of the printed matter 70 shown in FIG. 11.

FIG. 15 is an enlarged view showing one example of the portion A shown in FIG. 1.

### DESCRIPTION OF EMBODIMENT

### Embodiment 1.

Hereinafter, a printed matter and a printed matter manufacturing method according to the present disclosure will be described with reference to drawings. The present disclosure is not limited by Embodiment described hereinafter. In the respective drawings, identical components are given the same reference symbols, and the description of such components is partially omitted. The respective drawings are schematically drawn, and the present disclosure is not limited to the shape shown in the drawings.

### Item to be printed 70

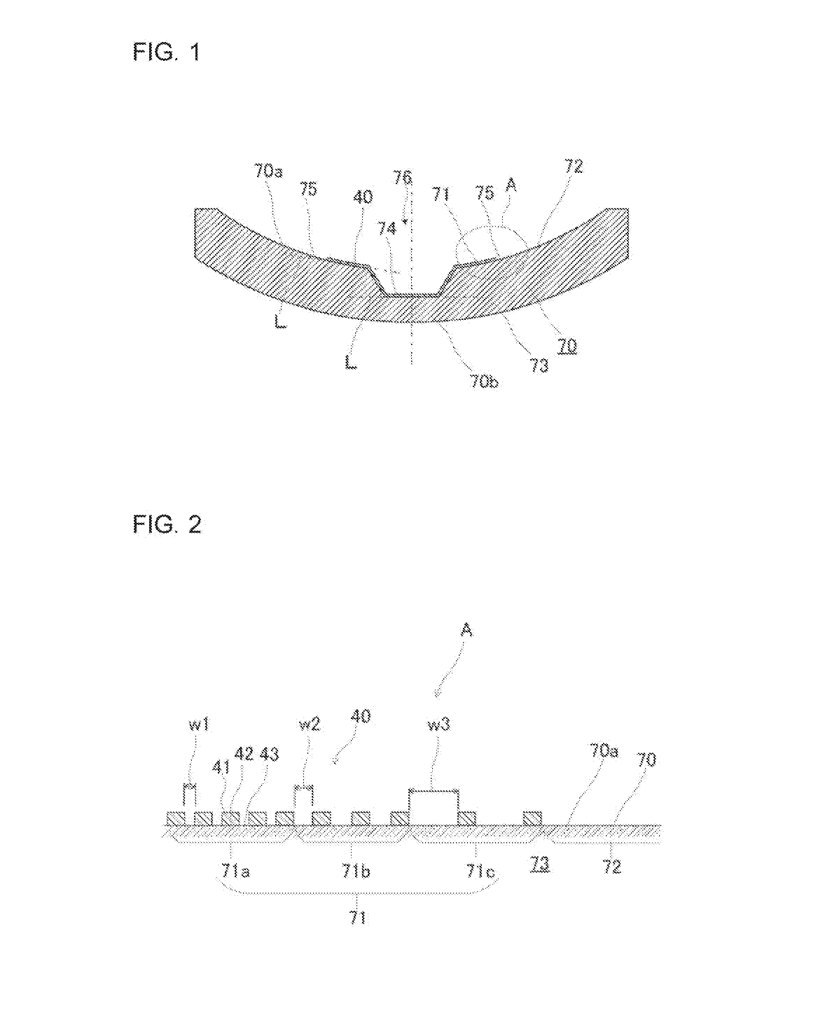

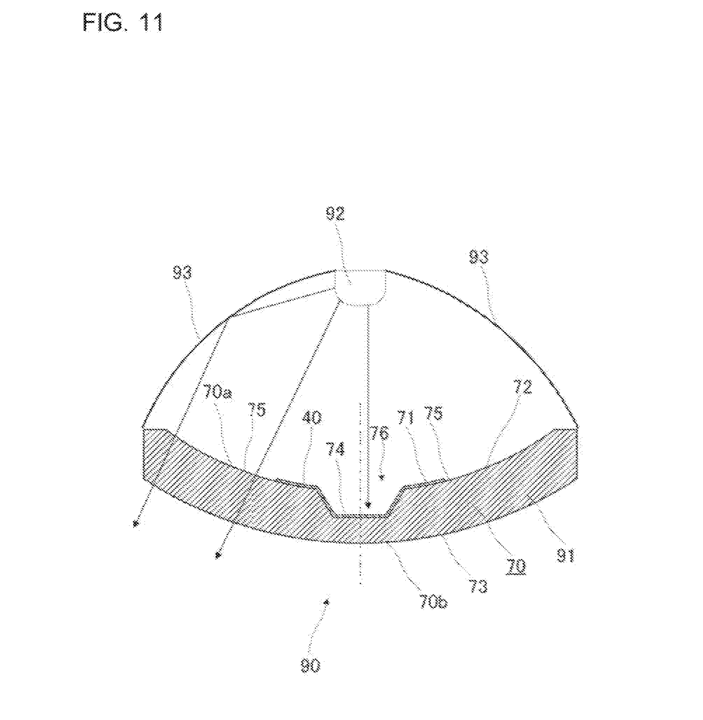

FIG. 1 is a diagram illustrating the cross-sectional structure of a printed matter 70 according to Embodiment 1. The printed matter 70 is an item in which a print image region 40 is formed on at least one surface 70a of a base body 73, being a molded product made of a transparent resin that allows transmission of light, for example. The one surface 70a of the printed matter 70, on which the print image region 40 is formed, is disposed in such a way as to face an LED lamp or the like, being a light source, for example. The other surface 70b of the printed matter 70 forms the appearance surface of lighting equipment 90, such as a tail lamp or a headlight of an automobile, for example (see FIG. 11). The printed matter 70 is configured such that the one surface 70a has a recessed portion 74, and the print image region 40 is formed on the entire or at least a portion of the recessed portion 74 and a peripheral surface 75 of the recessed portion 74. The shape of the printed matter 70 shown in FIG. 1 is merely one example, and the shape of the recessed portion 74 or the shapes of the peripheral surface 75 and the surfaces 70a, 70b may be suitably changed. It is not always necessary to form the entire base body 73 in such a way as to allow transmission of light. A configuration may be adopted in which only a portion of the base body 73 at which the print image region 40 is formed and portions around the print image region 40 may be formed by a part that allows transmission of light.

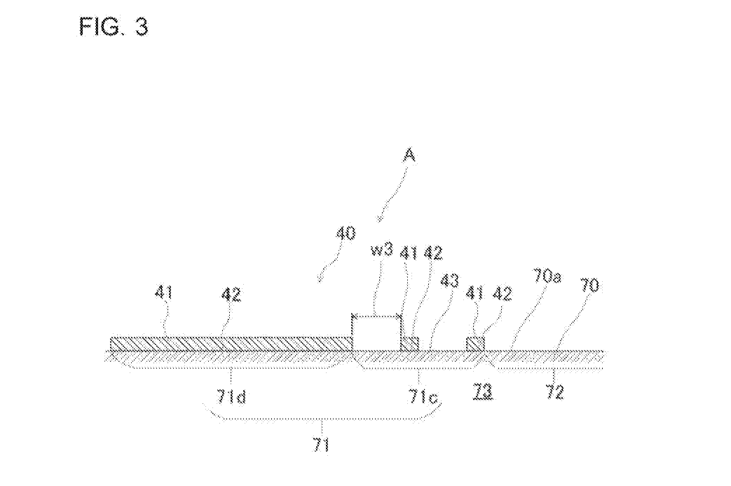

FIGS. 2 and 3 are enlarged views showing one example of a portion A shown in FIG. 1. FIG. 2 is a schematic cross sectional view showing the case where ink is arranged on the one surface of the printed matter 70 in a dotted manner. FIG. 3 is a schematic cross sectional view showing the case where ink is placed at least in the entire printing region 71d, being a portion of the print image region 40. The print image region 40 is formed by placing ink 41 on the one surface 70a of a printed matter 70. The region in which the ink 41 is placed on the one surface 70a of the printed matter 70 is referred to as "printing region 71". The surface 70a on which the printing region 71 is disposed includes a first portion 42 and a second portion 43, the first portion 42 being the portion of the surface on which the ink 41 is placed, the second portion 43 being the portion of the surface on which no ink 41 is placed.

The print image region 40 may include a plurality of printing regions 71a, 71b, 71c, and 71d having different arrangement densities of the first portion 42 at which the ink 41 is placed. In the printing region 71a shown in FIG. 2 and disposed at the leftmost portion, the ink 41 is arranged at intervals w1 in cross section. In the printing region 71b disposed on the right of the printing region 71a, the ink 41 is arranged at intervals w2. In the printing region 71c disposed on the right of the printing region 71b, the ink 41 is arranged at intervals w3. The respective printing regions 71a, 71b, and 71c differ in intervals at which the ink 41 is arranged, and are set to satisfy w1 < w2 < w3. In the printing region 71d shown in FIG. 3, the ink 41 is arranged throughout the entire region. The plurality of printing regions 71a, 71b, 71c, and 71d differ in arrangement density of the ink 41. In each of the plurality of printing regions 71a, 71b, 71c, and 71d, the ink 41 is arranged at a substantially uniform density in each of the printing regions. That is, in each of the plurality of printing regions 71a, 71b, 71c, and 71d, when any portion having a predetermined area in the printing region is observed, the portion has the same area of arrangement of the ink 41 (the same amount of the ink 41). A non-printing region 72 is a region in which no ink 41 is arranged. In other words, the non-printing region 72 is a region in which the arrangement density of the ink 41 is zero.

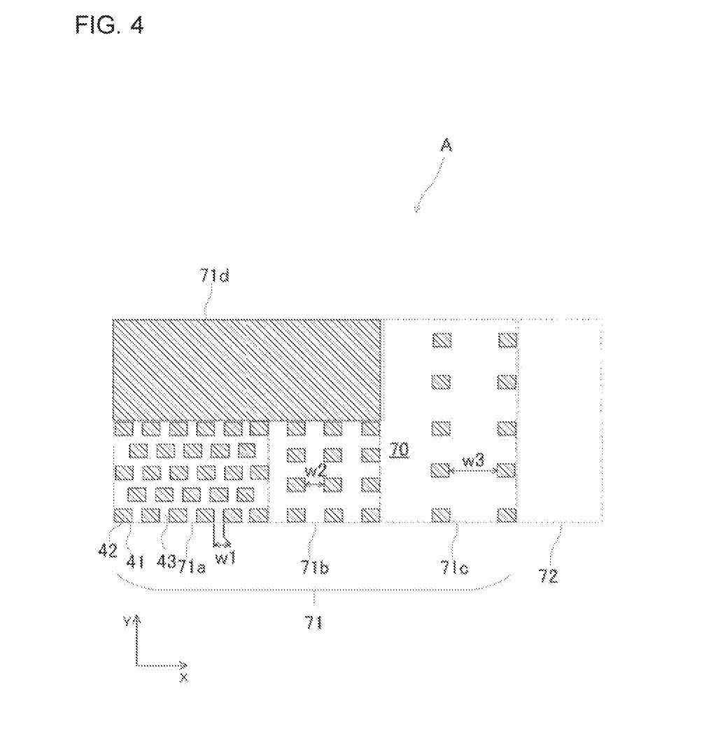

FIG. 4 is a plan view showing one example of the one surface 70a of the printed matter 70 shown in FIG. 1. The ink 41 (first portion) is arranged in the X direction and the Y direction in each of the printing regions 71a, 71b, 71c, and 71d, each of which has a different number of arrangements of the ink 41 per unit area, that is, has a different arrangement density. As shown in FIG. 4, the arrangement density of the ink 41 in the printing region 71a is higher than the arrangement density of the ink 41 in the printing region 71b and in the printing region 71c. The arrangement density of the ink 41 in the printing region 71b is higher than the arrangement density of the ink 41 in the printing region 71c. The arrangement density of the ink 41 in the printing region 71d is higher than the arrangement densities of the ink 41 in other printing regions 71a, 71b, and 71c. Assuming that a certain printing region 71 is referred to as "first printing region", the printing region 71 having a lower arrangement density of the ink 41 than the first printing region may be referred to as "second printing region". In other words, the printed matter 70 according to Embodiment 1 has the print image region 40, and the print image region 40 may include the plurality of printing regions 71a, 71b, 71c, 71d having different arrangement densities of the ink 41. The plurality of printing regions 71a, 71b, 71c, and 71d include the first printing region having a higher arrangement density of the first portion 42 than the second printing region. In other words, the second printing region has a higher density of the second portion 43, at which no ink 41 is placed, than the first printing region.

The printed matter 70 according to Embodiment 1 has the plurality of printing regions 71a, 71b, 71c, and 71d having different arrangement densities of the ink 41, thus allowing the respective portions of the printed matter 70 to have different amounts of light transmission. That is, in the case where the ink 41 arranged in the printing region 71 shown in FIGS. 2 to 4 has the same ingredients, the printing region 71a has a lower amount of light transmission than the printing region 71b, the printing region 71c, and the non-printing region 72. That is, in the case where the printed matter 70 is used as a cover of a tail lamp of an automobile, when the tail lamp is turned on, the printing regions 71a, 71b, and 71c appear as regions having different amounts of light transmission, thus forming a predetermined pattern.

A plurality of print image regions 40 shown in FIGS. 2 to 4 may be formed on the printed matter 70.

Further, in the case where the plurality of print image regions 40 are formed on the printed matter 70, the plurality of print image regions 40 may be formed by performing a plurality of printing processes, and printing may be performed such that the second printing regions of the print image regions 40 overlap with each other, the second printing regions having a low arrangement density of the ink 41. For example, printing is performed such that the printing region 71b of one print image region 40 overlaps with the printing region 71c of another printing region 71, and the printing region 71c of the one printing region 71 overlaps with another printing region 71b. The printing regions 71b and 71c having different arrangement densities of the ink 41 overlap with each other as described above, so that the entire image obtained by combining two print image regions 40 has a uniform arrangement density of the ink 41 as a whole. The print image regions 40 described in this paragraph are used when the print image regions 40 formed on the printed matter 70 are formed by performing the plurality of printing processes, that is, when there is a large printing area or when the printed matter 70 has a complicated surface shape, for example. With such a configuration, it is possible to form the print image regions 40 without forming a gap or the like between the adjacent print image regions 40 and without forming irregularities on the entire print image regions 40. That is, variation in position of printing of the respective print image regions 40, which otherwise occurs due to the plurality of printing processes, can be eliminated by causing the printing regions 71b and 71c, having low arrangement densities of the ink 41, to overlap with each other and hence, the print image regions 40 can be formed as a whole without irregularities.

In the case where, of the plurality of print image regions 40, each of two adjacent print image regions 40 has the arrangement structure of the ink 41 shown in FIG. 2, for example, the printing region 71a that is not caused to overlap is referred to as "first printing region", and the printing regions 71b and 71c that are caused to overlap in the above-mentioned description are referred to as "second printing regions". That is, each of two adjacent printing regions 71 has second printing regions having low arrangement densities of the ink 41, as in the case of the printing regions 71b and 71c, at the peripheral edge portion of the print image region 40. By causing the second printing regions of the two adjacent printing regions 71 to overlap with each other, it is possible to perform printing while the boundary between the two printing region 71 is prevented from being noticeable. The second printing regions may include a plurality of printing regions having different arrangement densities of the ink 41 as in the case of the printing regions 71b and 71c, or may include a larger number of printing regions. The second printing regions may be configured such that the arrangement density of the ink 41 is continuously reduced from the center portion toward the peripheral edge of the print image region 40.

In the case where the visible surface has a three-dimensional surface structure 76, as in the case of the base body 73 of the printed matter 70 shown in FIG. 1, it is desirable that the portion where the second printing regions of the two adjacent printing regions overlap with each other as described above be disposed at a position that allows the ink 41 from a printing pad 10 to be transferred as accurately as possible. Therefore, it is preferable that the portion where the second printing regions overlap with each other be disposed in such a way as to include, in cross section parallel to the direction along which the printing pad 10 is pushed, the portion of the three-dimensional surface structure 76 that has a tangent L being perpendicular to the direction along which the printing pad 10 is pushed. In FIG. 1, the bottom surface of the recessed portion 74 corresponds to the position that has the tangent L, which is perpendicular to the direction along which the printing pad 10 is pushed. For example, in the case where the second printing regions are caused to overlap with each other on the peripheral surface 75, it is preferable that the base body 73 be disposed in an inclined manner to cause the tangent L to be substantially perpendicular to the direction along which the printing pad 10 is pushed. Although it is desirable that the tangent L be perpendicular to the direction along which the printing pad 10 is pushed, practically, the tangent L that forms an angle of 0° to 30° with a surface perpendicular to the direction along which the printing pad 10 is pushed may be adopted for overlapping of the second printing regions.

In Embodiment 1, the ink 41 is shown as a rectangular dot as viewed in a plan view. However, the ink 41 is schematically shown and, in an actual apparatus, there may be cases where the ink 41 is formed into a circular shape or a shape close to a circular shape as viewed in a plan view. Rectangular ink 41 is shown also in FIGS. 2 and 3. However, the ink 41 shown in FIGS. 2 and 3 is also schematically shown and, in an actual apparatus, the ink 41 may have a rounded shape, such as a shape of a droplet placed on a surface having water repellency, for example.

The respective printing regions 71a, 71b, 71c, and 71d are configured such that each of the printing regions 71a, 71b, 71c, and 71d has a uniform arrangement density of the ink 41. However, the configuration is not limited to the above. For example, the arrangement density of the ink 41 may be continuously changed in such a way as to be gradually reduced in the direction from the left to the right in FIG. 2.

The arrangement of the ink 41 on the one surface 70a of the printed matter 70 has been described with reference to FIGS. 2 to 4. However, the above-mentioned arrangement of the ink 41 is not limited to the one surface 70a of the printed matter 70, and may also be provided to the other surface 70b. Alternatively, the above-mentioned arrangement of the ink 41 may be provided only to the other surface 70b.

### Printing apparatus 100

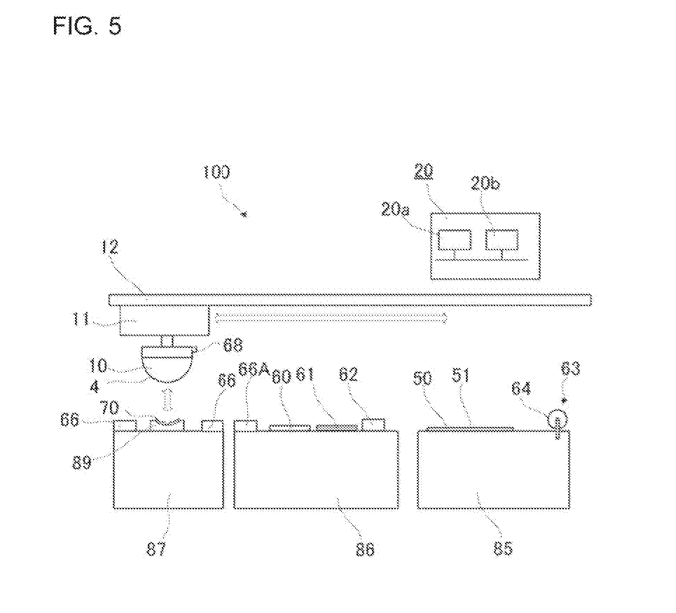

FIG. 5 is a side view showing one example of a printing apparatus 100 according to Embodiment 1. The printing apparatus 100 includes the printing pad 10 that can move linearly in the vertical direction. The printing pad 10 is a pad that is vertically moved by a vertically moving device 11 included in the printing apparatus 100, and that pushes a printing surface 4 against the surface to be printed of the printed matter 70. In Embodiment 1, the surface to be printed includes the recessed portion 74 and the peripheral surface 75 of the recessed portion 74. The printing apparatus 100 also includes a horizontally moving device 12. The horizontally moving device 12 moves the printing pad 10 and the vertically moving device 11 in the horizontal direction.

The printing pad 10 is moved, by the horizontally moving device 12, to an area above a cleaning device 60, an activation device 61, an air blowing device 62, or a printing original plate 50 in addition to the printed matter 70. The printing pad 10 is vertically moved by the vertically moving device 11, so that the printing surface 4 is pushed against the printed matter 70, the cleaning device 60, the activation device 61, or the printing original plate 50. In FIG. 5, the printing apparatus 100 includes, from the left, a printing stage 87, a surface treatment stage 86, and a printing original plate stage 85. The printed matter 70 is placed on the printing stage 87. The cleaning device 60 is provided to the surface treatment stage 86. The printing stage 87 includes a jig 89 and blowers 66. The jig 89 positions the printed matter 70. The blowers 66 send air toward the printing pad 10 on which the ink 41 is placed. The surface treatment stage 86 includes the activation device 61, the air blowing device 62, and a blower 66A that sends air to the printing pad 10 on which the ink 41 is placed. The printing original plate 50 is placed on the printing original plate stage 85. However, in the printing apparatus 100, these stages may be freely arranged, and the arrangement may be suitably changed according to the convenience of the operator or the location where the printing apparatus 100 is installed. There may be a case where the cleaning device 60, the activation device 61, the air blowing device 62, or the blowers 66 and 66A of the printing apparatus 100 is not installed in the printing apparatus 100.

### Printing pad 10

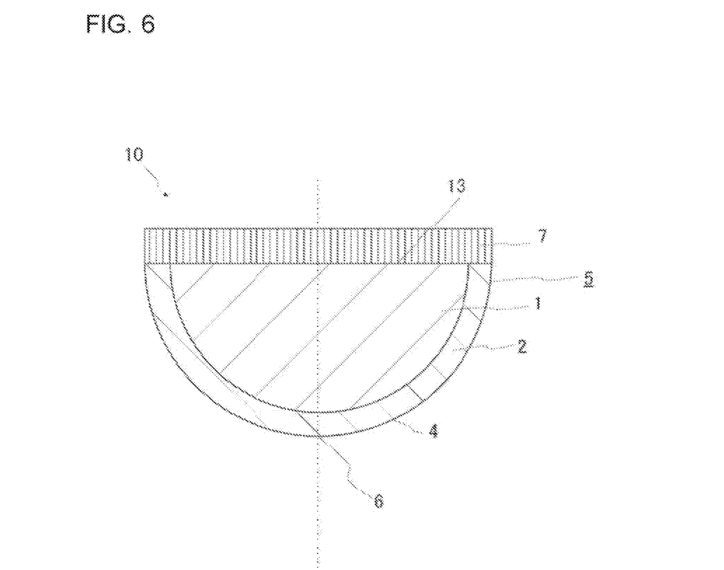

FIG. 6 is a cross-sectional view showing one example of the printing pad 10 included in the printing apparatus 100 according to Embodiment 1. FIG. 6 shows a cross section that passes through a top portion 6 of the printing pad 10 and that is perpendicular to a flat surface 13 to which a base 5 is fixed. As shown in FIG. 6, the base 5 of the printing pad 10 includes an inner layer 1 and an outer layer 2 that covers the surface of the inner layer 1. The printing pad 10 shown in FIG. 6 has a substantially hemispherical shape, for example. The shape of the printing pad 10 is not limited to such a shape, and may be suitably changed to, for example, a cannonball shape, a shape having a curved surface obtained by rotating a parabola about the axis of symmetry of the parabola, a shape of a portion of an ellipsoid obtained by cutting the ellipsoid or other shape, a shape obtained by contiguously extending the cross section of the cannonball shape or a semicircular shape along a straight line, or other shapes corresponding to the specifications or other factor of the printed matter 70. The printing pad 10 has the top portion 6 that comes into contact with the printed matter 70 or the printing original plate 50 first, and the top portion 6 is in the form of a point or a line. With such a configuration, when the printing pad 10 is pushed against the printed matter 70 or the printing original plate 50, there is no possibility of air being caught between the printing surface 4 and the printed matter 70 or the printing original plate 50. Accordingly, it is possible to prevent the generation of a void in a print image applied to the printed matter 70. In Embodiment 1, of the surface of the printing pad 10, a predetermined range centered about the top portion 6 forms the printing surface 4 to which ink is moved from the printing original plate 50 to transfer the ink to the printed matter 70.

FIG. 6 shows the case where the printing pad 10 forms the print image region 40 on the printed matter 70 by performing the printing process one time. However, the printing process may be performed in a different mode. For example, a configuration may be adopted in which the print image region 40 is formed by performing the printing process a plurality of times by using a small printing pad 10.

### Base 5

The base 5 is formed by molding silicone rubber, for example. The base 5 has elasticity (flexibility), and silicone oil is mixed to facilitate deformation. In Embodiment 1, the base 5 has a substantially hemispherical shape. However, the shape of the base 5 may be suitably changed corresponding to the specifications or other factor of the printed matter 70. When the printing pad 10 is pushed against the printing original plate 50, the base 5 is deformed to cause the ink 41 placed on a placement surface 51 of the printing original plate 50 to move to the printing surface 4. The ink 41 placed on the placement surface 51 of the printing original plate 50 is arranged corresponding to an image to be printed on the printed matter 70, thus forming a print pattern corresponding to the image. Provided that the base 5 can deliver the ink 41 to the surface to be printed when the printing pad 10 is pushed against the surface to be printed, the material of the base 5 is not limited.

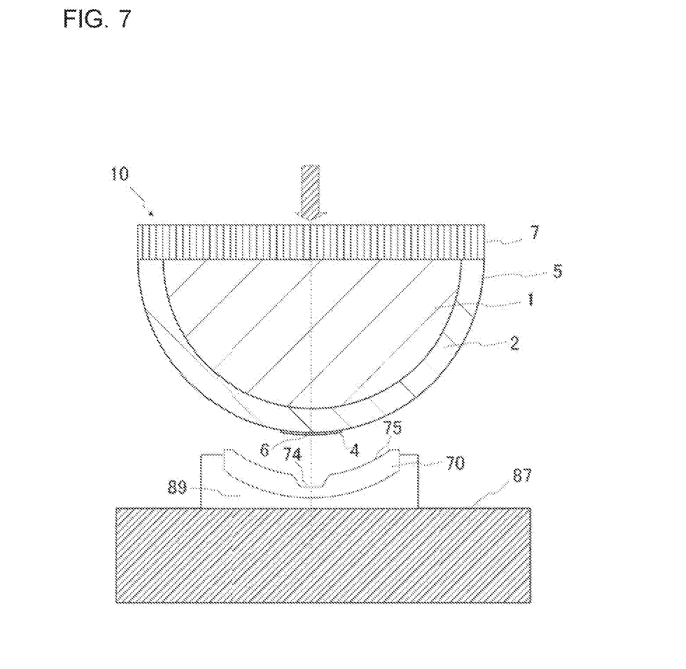

FIG. 7 is a cross-sectional view showing a state in which the printing pad 10 included in the printing apparatus 100 according to Embodiment 1 is pushed against the printed matter 70. For example, the base 5 may be made of two materials having different hardnesses. In such a case, for example, a material of the outer layer 2, forming a portion close to the printing surface 4, is set to a material having Asker C hardness in a range from 50 to 70 points. A material for forming the inner layer 1, disposed inside the outer layer 2, is set to a material having Asker C hardness of 100 points. The inner layer 1 is located at a position where the inner layer 1 can apply a force for pushing the printing surface 4 against the surfaces to be printed during printing, and is located at a position closer to a support part 7 than the outer layer 2. The support part 7 is a portion that is connected to the vertically moving device 11, and that transfers a force from the vertically moving device 11 to the printing pad 10. In FIG. 7, Asker C hardness of the upper portion of the base 5 is set to 100 points, and Asker C hardness of the lower portion of the base 5 (a portion of the base 5 including the top portion 6) is set in a range from 50 to 70 points. To allow the printing pad 10 to be deformed to conform to the surfaces to be printed, it is desirable to set hardness of the printing pad 10 to a low level. Therefore, hardness of the portion of the printing pad 10 including the printing surface 4, pushed against the printed matter 70, is set to a level lower than the level of hardness of portions disposed above such a portion. Such a configuration allows the shape of the entire printing pad 10 to be easily held. In addition to the above, the outer layer 2, which is directly pushed against the surfaces to be printed, has an advantage that the outer layer 2 can be easily deformed to conform to the recessed portion 74 of the surface to be printed and to conform to the peripheral surface 75 of the recessed portion 74. However, hardnesses of the respective portions of the base 5 are not limited to the above-mentioned hardnesses.

### Cleaning device 60

As shown in FIG. 5, the surface treatment stage 86 is disposed adjacent to the printing stage 87 of the printing apparatus 100. The cleaning device 60 is installed on the surface treatment stage 86. The cleaning device 60 includes a piece of paper or an adhesive tape, for example. The printing surface 4 of the printing pad 10 is pushed against the surface of the piece of paper or the adhesive tape, so that the ink 41, stains, dust and other substance remaining after printing are removed.

### Activation device 61

The activation device 61 includes a storage tank that stores liquid, and an absorbing unit that absorbs and holds the liquid. When the printing surface 4 of the printing pad 10 is pushed against the surface of the absorbing unit, the liquid held by the absorbing unit thereby adheres to the printing surface 4 of the printing pad 10. The printing pad 10 is a pad where water or solvent is caused to adhere to or permeate into the base 5 to facilitate transfer of the ink 41 placed on the printing original plate 50 to the printing surface 4. A liquid is suitably selected on the basis of its properties having compatibility with ingredients contained in the ink 41, and the liquid has properties of softening a hard ink 41. The ink 41 is a mixture of a synthetic resin, such as an acrylic resin or a urethane resin, and water, thinner, xylene, toluene, or other substance. It is preferable to select a mixture having a high affinity for a solvent contained in the ink 41. However, a liquid used for the activation device 61 is not limited to the above.

The absorbing unit of the activation device 61 is formed by laminating thin absorbing materials each having a sheet shape, for example. The absorbing material is a piece of paper, for example. However, the absorbing material is not limited to only a piece of paper. As long as the absorbing material absorbs liquid, the absorbing material may be any of other materials, such as a cloth and a resin. For example, the absorbing unit may be a unit obtained by laminating pieces of paper on a sponge-like resin. There may be a case where stains, such as the ink 41 remaining on the printing surface 4 of the printing pad 10, adhere to the surface of the absorbing unit, against which the printing surface 4 of the printing pad 10 is pushed, or a case where a piece of paper forming the absorbing unit is torn as the surface of the absorbing unit is scratched. For this reason, the absorbing unit is formed such that the laminated pieces of paper can be removed one by one by peeling off and removing the piece of paper positioned in the uppermost layer of the absorbing unit from the uppermost layer of the absorbing unit, or an upper layer portion can be mechanically replaced. However, a method for replacing a piece of paper positioned in the uppermost layer is not limited to the above. The absorbing unit is formed such that a piece of paper or other material forming the uppermost layer can be removed or replaced and hence, the surface of the absorbing unit is always maintained clean, and liquid permeates through the surface of the absorbing unit, therefore, pushing the printing surface 4 of the printing pad 10 can activate a printing surface.

### Air blowing device 62

The air blowing device 62 is a device that adjusts the amount of water or solvent caused to adhere to the printing surface 4 of the printing pad 10 by the activation device 61 to an appropriate amount. The air blowing device 62 removes excess water or solvent from the printing surface 4 by blowing air toward the printing surface 4. The type of the air blowing device 62, the number of air blowing devices 62, and the direction along which air is blown are not limited.

### Printing original plate stage 85

The printing original plate 50 is placed on the upper surface of the printing original plate stage 85. The printing original plate stage 85 includes an ink placement device 63 that places ink on the printing original plate 50. The ink placement device 63 includes a roller 64 that holds ink, for example, and the roller 64 is caused to rotate on the printing original plate 50 to place ink on the printing original plate 50. The ink placement device 63 may be the head of an ink jet system installed in such a way as to be movable in the horizontal direction. In this case, the head is provided to place ink on the surface of the printing original plate 50 by the ink jet system, and is configured to be movable along a moving rail. The ink placement device 63 is not limited to the above, and may adopt other modes.

### Printed Matter Manufacturing Method by using printing apparatus 100

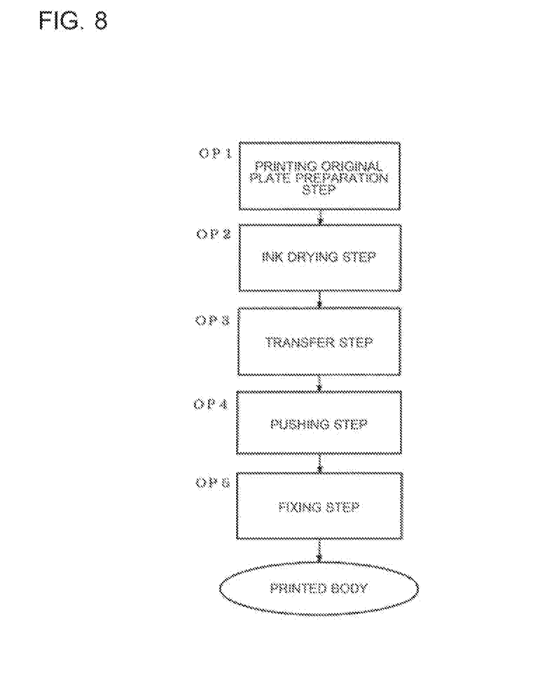

FIG. 8 shows a flow of a printed matter manufacturing method with the printing apparatus 100 according to Embodiment 1. Hereinafter, the printed matter manufacturing method with the printing apparatus 100 will be described with reference to FIGS. 5 and 8. As shown in FIG. 5, the printing apparatus 100 includes a controller 20. The controller 20 is a microcomputer, for example, and includes an arithmetic unit 20a and a storage device 20b. The functions of the controller 20 are implemented by using the arithmetic unit 20a and the storage device 20b (see FIG. 5).

The storage device 20b is a ROM, a RAM, or the like, for example, the ROM holding a program and data, for example, in advance, the RAM being provided for temporarily storing data in executing the program. As the storage device 20b, a nonvolatile or volatile semiconductor memory is used, such as a flash memory, an erasable and programmable ROM (EPROM), and an electrically erasable and programmable ROM (EEPROM). Further, as the storage device 20b, for example, a detachable recording medium may be used, such as a magnetic disk, a flexible disk, an optical disc, a compact disc (CD), a mini disc (MD), and a digital versatile disc (DVD). The storage device 20b can store information obtained from the temperature sensor 68 or other sensors and information processed by the arithmetic unit 20a.

The arithmetic unit 20a is a unit that performs various processes for executing the functions of the controller 20. The arithmetic unit 20a compares information on the temperature of the room from the temperature sensor, for example, with the threshold of a temperature stored in the storage device 20b in advance to determine whether the temperature of the room is higher than the threshold. When the temperature of the room is higher than the threshold, the controller 20 performs a control of suppressing output from the heater included in each blower 66 at a predetermined value. When the temperature of the room is higher than the threshold, the controller 20 may perform a control of shortening an operation time period of the blowers 66. Alternatively, the controller 20 may perform a control of restricting a time period during which the printing pad 10 is stopped in front of the blowers 66 to receive air.

### Printing original plate preparation step OP1

As shown in FIG. 8, in the printed matter manufacturing method, first, a printing original plate preparation step OP1 is performed in which a print image is formed on the placement surface 51 of the printing original plate 50. As shown in FIG. 4, the printing original plate 50 has a flat plate shape, and is placed on the printing original plate stage 85. In Embodiment 1, the printing original plate 50 is a thin flat plate made of an aluminum alloy. However, a sheet material that is referred to as "design receiving sheet" and that has retentivity of and excellent affinity for UV ink may also be used for the printing original plate 50. Further, the sheet material can have increased retentivity of and affinity for ink by forming unevenness on the sheet material. The surface of the printing original plate 50 is finished to have predetermined surface roughness. The ink placement device 63 may be configured such that the ink placement device 63 can be moved in the horizontal direction by a feeding device not shown in the drawing at least in an area above the printing original plate 50. Alternatively, a configuration may be adopted in which the printing original plate 50 can be moved relative to the ink placement device 63. Alternatively, a configuration may be adopted in which, as in the case of the printing original plate stage 85 shown in FIG. 1, the ink placement device 63 includes the roller 64 that holds ink, and the roller 64 is caused to rotate on the printing original plate 50 to place ink on the printing original plate 50, or an image may be formed by the ink jet system under computer control. Even in the case of performing offset printing on the printed matter 70 having a curved surface as shown in FIG. 1, the same printing original plate preparation step OP1 is performed. In the case of performing printing by the ink jet system, a print image is obtained by discharging fine ink drops from nozzles provided to the head as the ink placement device 63 and by blowing the ink drops to the printing original plate 50. In addition to storage portions and nozzles for inks of four colors of red, blue, yellow, and black, for example, the head includes a storage portion that stores intermediate color ink having intermediate color of the four colors, and includes a nozzle that discharges the intermediate color ink. The head may be configured to arrange dots of inks of five different colors including at least the intermediate color ink on the surface of the printing original plate 50.

### Ink drying step OP2

After the printing original plate preparation step OP1 is finished, an ink drying step OP2 is performed. Immediately after the printing original plate preparation step OP1 is finished, the viscosity of the ink 41 on the printing original plate 50 is low. If the low viscosity of the ink 41 on the printing original plate 50 is maintained, the ink 41 is distorted and is not transferred to the printing pad 10 with high accuracy when the printing pad 10 is pushed against the ink 41 on the printing original plate 50. Further, accuracy of a print image is reduced due to oozing of the ink 41, for example. For this reason, in the ink drying step OP2, a solvent contained in the ink 41 is evaporated to increase the viscosity of the ink 41.

In the ink drying step OP2, air is sent to the ink 41 on the printing original plate 50 or the ink 41 on the printing original plate 50 is heated to evaporate the solvent in the ink 41. Alternatively, for example, the ink 41 may be subject to natural air drying for a predetermined time period in a state in which the printing original plate 50 is placed on the printing original plate stage 85. The solvent has higher volatility than other ingredients in the ink 41. The viscosity of ink is increased in such a manner that the solvent is evaporated from the ink 41 by sending air or the like to increase the proportion of ingredients other than the solvent in the ink. When the ink drying step OP2 is completed, the viscosity of the ink 41 is adjusted to 3 Pa·s to 1000 Pa·s, for example. It is desirable that the time period during which ink is dried be set corresponding to the time period required for performing a transfer step OP3 and a pushing step OP4, which are steps performed after the ink drying step OP2. With such a configuration, the printing can be continuously performed on a large number of printed matters 70 efficiently.

When the process advances from the printing original plate preparation step OP1 to the ink drying step OP2, the printing original plate 50 may be moved from the printing original plate stage 85, or may remain placed on the printing original plate stage 85. In the case where the printing original plate 50 is moved from the printing original plate stage 85, another printing original plate 50 can be immediately plated on the printing original plate stage 85, thus allowing the printing original plate preparation step OP1 to be started. Therefore, there is an advantage that a cycle time of the entire offset printing process can be shortened.

The ink 41 on the printing original plate 50 may be dried in such a manner that, for example, a blower and a heater are installed next to the ink placement device 63, and air that passes through the heater is sent to an area above the printing original plate 50 by the blower. The heater installed together with the blower is set to a temperature as high as possible within a range of less than the boiling point of the solvent contained in the ink 41. A solvent that is semi-dried in the ink drying step OP2 is selected for the solvent contained in the ink 41. For example, a solvent having a flash point of 40 degrees C or more and a boiling point of 120 degrees C or more is selected. In such a case, the temperature of the heater is set to 100 degrees C, for example. A solvent having high solvency may damage the ink placement device 63 and hence, it is desirable to use a solvent having low solvency. However, the ink 41 used in the printing apparatus 100 is not limited to the above-mentioned ink.

In the case where the ink 41 having low viscosity is use, such as the case of an ink jet system, there may be cases where the above-mentioned ink drying step OP2 is performed. However, when the viscosity of the ink 41 is adjusted to an appropriate value and when the ink 41 having appropriate viscosity is placed on the printing original plate 50, the ink drying step OP2 may be omitted. For example, in the case where the ink 41 having adjusted viscosity is placed on the printing original plate 50 with the roller 64, the process may omit the ink drying step OP2 and may advance to the next step. The ink 41 may be dried in a state in which the ink 41 is placed on the printing pad 10. In this case, air is sent to the surface of the printing pad 10 by the blower 66 or 66A.

### Transfer step OP3

As shown in FIG. 8, in the transfer step OP3, in the case where printing is performed by using the printing pad 10 having a curved surface, such as a parabolic surface, the printing pad 10 is pushed against the printing original plate 50 from the apex to transfer a print image.

### Pushing step OP4

As shown in FIG. 8, in the pushing step OP4, the printing pad 10 is pushed against the printed matter 70. The ink 41 adhering to the surface of the printing pad 10 is transferred to the surface of the printed matter 70. In the case where printing is performed by using the printing pad 10, even when the surface of the printed matter 70 has a curved surface, the printing can be performed to conform to such a shape. Before the pushing step OP4 is performed, the base body 73 is positioned at a point above the printing stage 87. The positioning of the base body 73 is performed by using the jig 89. In the case where the pushing step is performed on the printed matter 70 a plurality of times, an adjustment may be made such that the posture of the printed matter 70 is changed by changing the jig 89 each time to cause the printing pad 10 to be pushed against the surface of the base body 73 at a desired position and angle. However, the configuration is not limited to the above, and the pushing step may be performed a plurality of times without changing the posture of the printed matter 70.

### Fixing step OP5

As shown in FIG. 8, in a fixing step OP5, the ink 41 transferred to the surface of the printed matter 70 in the pushing step OP4 is fixed. In the case where UV ink is used as the ink 41, an ultraviolet light irradiation device (not shown in the drawing) may irradiate the surface of the printed matter 70 with ultraviolet light in this step to cure the ink 41. Alternatively, the surface of the printed matter 70 may be irradiated with an electron beam instead of ultraviolet light. In the case where the shape of the printed matter 70 has a curved surface, it is desirable to use the ultraviolet light irradiation device 80 that can emit ultraviolet light along the surface having the curved surface.

In the fixing step OP5, the ink 41 is not limited to be cured by being irradiated with ultraviolet light or an electron beam. For example, the ink 41 may be cured by being heated by the heater or may be cured by being dried by sending air onto the ink 41. The ink 41 may also be cured by natural air drying.

### Action of printing apparatus 100

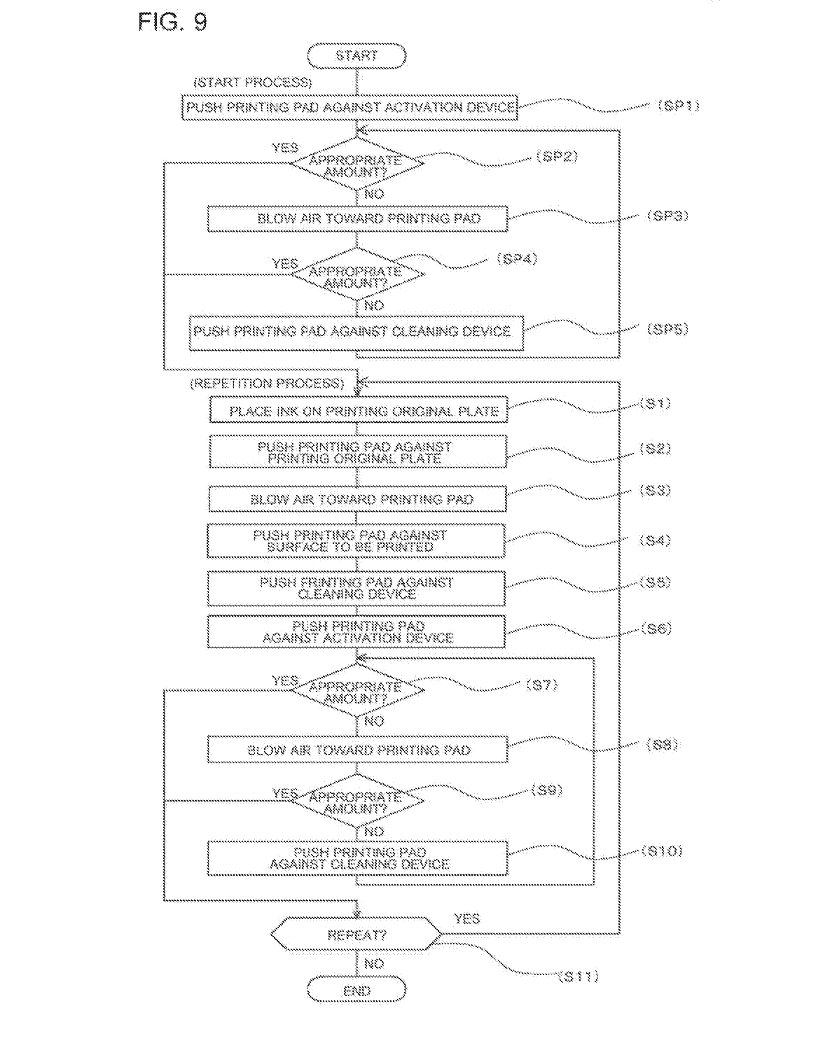

FIG. 9 shows the flow of the action of the printing apparatus 100 according to Embodiment 1. In performing the above-mentioned printed matter manufacturing method shown in FIG. 8, the printing apparatus 100 operates according to the flow shown in FIG. 9.

(Start process)

The start process is a process performed immediately after the printing apparatus 100 is turned on. Immediately after the production of the printed matter is started, there may be the case where the surface of the printing pad 10 is not activated. Therefore, a step of appropriately activating the printing surface 4 of the printing pad 10 is performed. First, after the printing apparatus 100 is turned on, the printing apparatus 100 causes the printing pad 10 to move to an area above the activation device 61 and, then, to move downward toward the activation device 61. After the printing surface 4 is pushed against the absorbing unit of the activation device 61, so that a predetermined range including the printing surface 4 comes into contact with the absorbing unit, the printing pad 10 is elevated. Such an operation is referred to as an activation step (SP1). By performing such a step, liquid, such as water or solvent, permeating into the absorbing unit of the activation device 61 adheres to or permeates into the printing surface 4 of the printing pad 10. Unevenness is formed on the surface of the printing pad 10, so that liquid permeates into the absorbing unit. This step is referred to as "start first step".

After the start first step is completed, it is determined whether the amount of liquid adhering to the printing surface 4 of the printing pad 10 is appropriate (SP2). When the amount of the liquid adhering to the printing surface 4 is not appropriate (NO in SP2), the printing apparatus 100 performs an air blowing step (SP3). In the air blowing step, the air blowing device 62 blows air toward the printing surface 4 of the printing pad 10 to remove excess liquid adhering to the printing surface 4. The case where the amount of liquid adhering to the printing surface 4 is not appropriate means the case where the excessively large amount of liquid adheres to the printing surface 4. The above step is referred to as "start second step".

After the start second step is completed, it is determined whether the amount of liquid adhering to the printing surface 4 of the printing pad 10 is appropriate (SP4). When excess water or solvent still adheres to the printing surface 4 of the printing pad 10 (NO in SP4), the printing apparatus 100 performs an absorption step (SP5). In the absorption step, the printing apparatus 100 pushes the printing surface 4 of the printing pad 10 against the cleaning device 60. With such an operation, the excess liquid adhering to the printing surface 4 of the printing pad 10 is removed. The above step is referred to as "start third step".

When the amount of water or solvent adhering to or permeating into the printing pad 10 is appropriate, one or both of the air blowing step (SP3) and the absorption step (SP5) may be omitted. The order of performing the air blowing step and the absorption step may be changed. Further, the air blowing step (SP3) and the absorption step (SP5) of the start step may be performed a plurality of times.

(Repetition process)

After the start process is completed, and the printing surface 4 of the printing pad 10 is appropriately activated, the process advances to the repetition process. The repetition process includes an ink placement step (S1), an ink transfer step (S2), a drying step (S3), a pushing step (S4), a cleaning step (S5), an activation step (S6), an air blowing step (S8), and an absorption step (S10). As shown in FIG. 9, the printing apparatus 100 performs the ink placement step (S1), the ink transfer step (S2), the drying step (S3), the pushing step (S4), the cleaning step (S5), the activation step (S6), the air blowing step (S8), and the absorption step (S10) in this order. However, the order of steps in the repetition process is not limited to such an order. For example, after the ink placement step (S1) and the ink transfer step (S2) are completed, the printing apparatus 100 performs steps from the drying step (S3) to the absorption step (S9). However, the printing apparatus 100 may perform the ink placement step (S1) of a next cycle in parallel while the steps from the drying step (S3) to the absorption step (S9) are performed.

An ink placement step (S1) corresponds to the printing original plate preparation step OP1 in the printed matter manufacturing method shown in FIG. 8. An ink transfer step (S2) corresponds to the transfer step OP3 in the printed matter manufacturing method shown in FIG. 8. Before a pushing step (S4) is performed, a drying step (S3) may be performed in which the viscosity of the ink 41 on the printing surface 4 is increased by sending air to the printing surface 4 of the printing pad 10. The drying step (S3) may or may not be performed depending on the viscosity of the ink 41 on the printing original plate 50. The pushing step (S4) corresponds to the pushing step OP4 in the printed matter manufacturing method shown in FIG. 8. In the case of the printing apparatus 100 according to Embodiment 1, a step of moving the printing pad 10 to an area above the base body 73 is included between the ink transfer step (S2) and the pushing step (S4). A process including the ink transfer step (S2), the step of moving the printing pad 10 to an area above the base body 73, and the pushing step (S4) may be referred to as "printing process".

In the repetition process, a printed matter 70 is completed each time the pushing step (S4) is performed. The number of printed matters 70 is not limited to one, and printing may be performed on a plurality of printed matters simultaneously. In the case where the printing is performed on the plurality of printed matters simultaneously, a plurality of printing pads 10 may be installed to the printing apparatus 100.

(Cleaning step)

In the Cleaning step (S5), the printing surface 4 of the printing pad 10 from which the ink 41 is transferred to the surface to be printed is pushed against a flat cleaning surface of the cleaning device 60. The ink 41 remaining on the printing pad 10 is caused to adhere to the cleaning surface. The cleaning surface is a piece of paper or an adhesive tape. However, the material of the cleaning surface is not limited to the above.

(Activation step, air blowing step, absorption step)

The activation step (S6) is a step substantially equal to the activation step (SP1) in the start process. The air blowing step (S8) is a step substantially equal to the air blowing step (SP3) in the start process. The absorption step (S10) is a step substantially equal to the absorption step (SP5) in the start process. The air blowing step (S8) and the absorption step (S10) are performed corresponding to the amount of liquid, such as water or solvent, adhering to the printing surface 4 of the printing pad 10. Either one of the air blowing step (S8) or the absorption step (S10) may be omitted, or at least one of either the air blowing step (S8) or the absorption step (S10) may be performed a plurality of times. Each of the air blowing step (S8) and the absorption step (S10) is a step that is performed corresponding to the activation state of the printing surface 4 after the state of the printing surface 4 of the printing pad 10 is checked before the air blowing step (S8) or the absorption step (S10) is performed. When the state of the printing surface 4 of the printing pad 10 is checked in the checking step (S7 and S9), and the activation state of the printing surface 4 is appropriate, it is determined whether the printing is performed again in a repetition determination step (S11). When the printing is performed again (YES in S11), steps starting from the ink placement step (S1) is repeated again. When the printing is not repeated (NO in S11), the production of a printed matter is finished.

As described above, the printing apparatus 100 is an apparatus that performs the start process when the printing apparatus 100 is turned on, and that performs the repetition process thereafter to perform printing on a large number of printed matters 70. Provided that the printing pad 10 is in an activated state, the above-mentioned start process (SP1 to SP5) may be omitted.

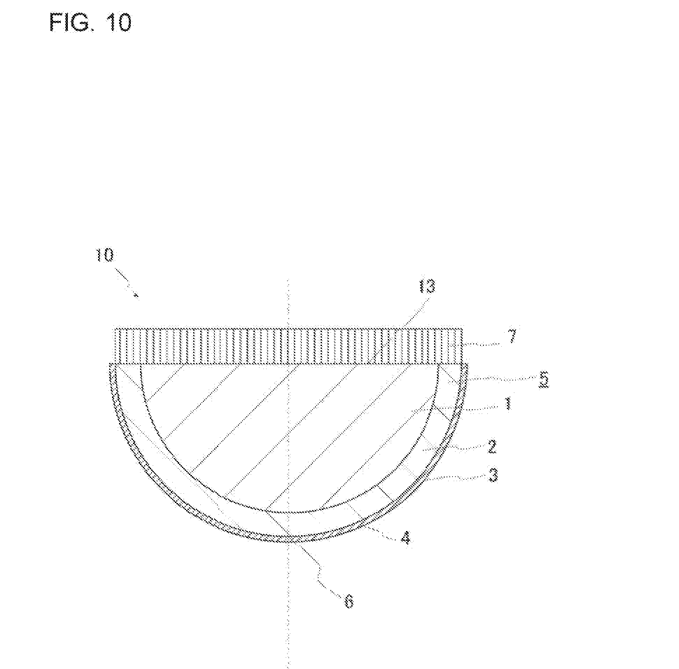

FIG. 10 shows a modification of the printing pad 10 used in the printing apparatus 100 of Embodiment 1. The printing pad 10 according to Embodiment 1 may include a protective film layer 3 that covers the surface of the base 5. The protective film layer 3 forms the printing surface 4 being an outer surface of the printing pad 10. The protective film layer 3 is formed by attaching a silicone rubber sheet with a thickness of 0.5 mm, for example, to the surface of the outer layer 2. The protective film layer 3 is provided to prevent silicone oil contained in soft silicone rubber forming the inner portion from oozing to the printing surface 4. Further, the outer surface of the protective film layer 3 forms the printing surface 4, and is repeatedly pushed against the printing original plate 50 and the surfaces to be printed and hence, it is necessary for the outer surface of the protective film layer 3 to have durability against scratches and wear. For this reason, the protective film layer 3 is formed using a material having higher hardness than the outer layer 2, and has a small thickness to conform to the surfaces to be printed when the printing surface 4 is pushed against the surface to be printed. In Embodiment 1, the protective film layer 3 is formed with a thickness as small as possible. It is preferable to form the protective film layer 3 with a thickness of 0.1 mm to 1 mm, for example. The material of the protective film layer 3 is not limited to silicone rubber, and any material may be suitably selected as long as the material conforms to the deformation of the inner layer 1 and the outer layer 2. Further, it is desirable that the protective film layer 3 has sufficient stretchability to allow the protective film layer 3 to be attached along the surface of the base 5 in a step of attaching the protective film layer 3 to the base 5. Further, the printing pad 10 may have a multilayer structure. For example, it is also possible to allow the inner layer 1 or the outer layer 2 of the printing pad 10 shown in FIG. 10 to have a multilayer structure made of materials having further different hardnesses.

The protective film layer 3 is attached to the surface of the base 5. However, when damage, such as scratches or wear, occurs on the protective film layer 3, the protective film layer 3 may be peeled off from the surface of the base 5 and replaced with a new protective film layer. The protective film layer 3 is less expensive than the base 5, and replacing the protective film layer 3 allows the base 5 disposed inside the protective film layer 3 to be directly used without any change. Therefore, renewing the protective film layer 3 allows the expensive base 5 to be repeatedly used, and it is possible to maintain the printing surface 4 of the printing pad 10 in a state suitable for printing. As a result, the printing apparatus 100 according to Embodiment 1 can reduce cost required for printing. In FIG. 9, the base 5 is formed by the inner layer 1 and the outer layer 2. However, the base 5 may have only one layer formed by the inner layer 1. That is, the protective film layer 3 may be provided to the base 5 having only one layer formed by the inner layer 1. However, when the protective film layer 3 attached to the base 5 is replaced, there may be cases where the base 5 is damaged through an operation of peeling the protective film layer 3, or the surface of the base 5 is subjected to deterioration, such as hardening. Therefore, it is desirable that the base 5 has a multilayer as shown in FIG. 10.

(Advantageous effect of printed matter 70)

The printed matter 70 according to Embodiment 1 is the printed matter 70 formed by pushing the printing pad to transfer ink placed on the surface of the printing pad, and the printed matter 70 includes the base body 73 made of a material that allows transmission of light, the visible surface of the base body 73 having a three-dimensional surface structure having a depth, the print image region 40 provided on at least one surface of the base body 73, the print image region 40 being a region in which the ink 41 is placed, and the non-printing region 72 provided to the one surface 70a, the non-printing region 72 being a region in which no ink 41 is placed. The print image region 40 is provided in an area including the three-dimensional surface structure formed on the one surface of the base body 73, and the print image region 40 has a smaller amount of light transmitted than the non-printing region 72.

With such a configuration, when the printed matter 70 is disposed in the vicinity of a light source, as in the case of a tail lamp, a headlight, or a backlight of an automobile, for example, and when light transmits through the printed matter 70, a difference occurs in the amount of light transmitted between the print image region 40 and the non-printing region. For example, the print image region 40 has a smaller amount of light transmitted compared with the non-printing region 72, thus appearing dark. In contrast, the non-printing region 72 can be visually perceived in a state in which light is allowed to transmit through the base body 73 without any change. In the case where the base is red and is made of a material that allows transmission of light, the printed matter 70 allows transmission of red light, so that the printed matter 70 is visually perceived as a red lamp being turned on. The color of the ink 41 arranged in the print image region 40 is set to a color similar to the color of the base body 73. Such a configuration can, in the case where the light source is not in a turned-on state, prevent the print image region 40 from being noticeable when the printed matter 70 is viewed from the other surface side of the printed matter 70. In the case where the base body 73 of the printed matter 70 is colorless transparent or is close to colorless transparent, it is possible to prevent the print image region 40 from being noticeable by using ink 41 of a color similar to a color of the background that can be seen through the base body 73. The above-mentioned printed matter 70 is not limited to the case where the ink 41 is placed on the one surface 70a. Even in the case where the ink 41 is also placed on the other surface 70b, it is possible to obtain substantially the same advantageous effect.

(Modification of printed matter 70)

FIG. 11 is a schematic view showing a case where the printed matter 70 according to Embodiment 1 is used in the lighting equipment 90. In the lighting equipment 90, the printed matter 70 used as an illumination cover 91 is disposed in such a way as to cover a light source 92 and a reflection surface 93. To allow visual perception of a turned-on state of the light source not only from the front side of the lighting equipment 90 but also from the oblique direction, or to allow a wide area around the light source 92 to be irradiated with light, the illumination cover 91 has unevenness, that is, the three-dimensional surface structure 76 having a depth, on the one surface 70a that is directed toward the light source 92. FIG. 11 shows the structure in which the printed matter 70 has one recessed portion 74 at the center portion of a curved surface as the three-dimensional surface structure 76. However, the structure of the printed matter 70 is not limited to the above, and also includes a structure in which a large number of recessed portions 74 are further provided to the one surface 70a of the base body 73 and a structure in which the shape of the recessed portion 74 is changed. The three-dimensional surface structure 76 may also be configured to, when the light source 92 is in a turned-on state, prevent the light source 92 disposed in the lighting equipment 90 from being clearly seen as viewed from the other surface 70b side of the printed matter 70. The printed matter 70 according to Embodiment 1 may also be used as such an illumination cover 91. By suitably changing the shape of the print image region 40, it is possible to freely form the shape of the portion of the illumination cover 91 that emits strong light.

It is possible to control the amount of light transmitted through the print image region 40 by adjusting the arrangement density of the ink 41 as described with reference to the printing regions 71a, 71b, 71c, and 71d. The print image region 40 includes the first printing region and the second printing region, and the first printing region may be configured to have a higher arrangement density of ink than the second printing region. For example, when the first printing region is configured in the manner of the printing region 71a shown in FIG. 4 and when the second printing region is configured in the manner of the printing region 71b shown in FIG. 4, it is possible to obtain a difference in the amount of light transmission in the print image region 40 having a small amount of light transmission. Accordingly, it is also possible to cause a fine pattern to appear on the printed matter 70 when the light source 92 is in a turned-on state.

The print image region 40 may include a plurality of print image regions 40. Each of the plurality of print image regions 40 includes the above-described first printing region and second printing region, and the second printing regions of two adjacent print image regions 40 of the plurality of print image regions 40 may overlap with each other. Such a configuration allows the entire region of the whole image formed by combining the plurality of print image regions 40, for example, to have a substantially uniform arrangement density of the ink 41. Therefore, it is also possible to form the print image regions 40 in a wide area on one surface of the base body 73, for example. Also in the case where the one surface 70a of the base body 73 has a complicated three-dimensional surface structure, it is possible to suppress the generation of transfer omission of the ink 41 by performing the pushing step, in which the print image region 40 is formed only in an area with which the surface of the printing pad 10 can be easily brought into close contact when the printing pad 10 is pushed against the base body 73, and by repeatedly performing the pushing step a plurality of times. From such a point, the printed matter 70 is suitable for being used as the illumination cover 91 having the three-dimensional surface structure 76.

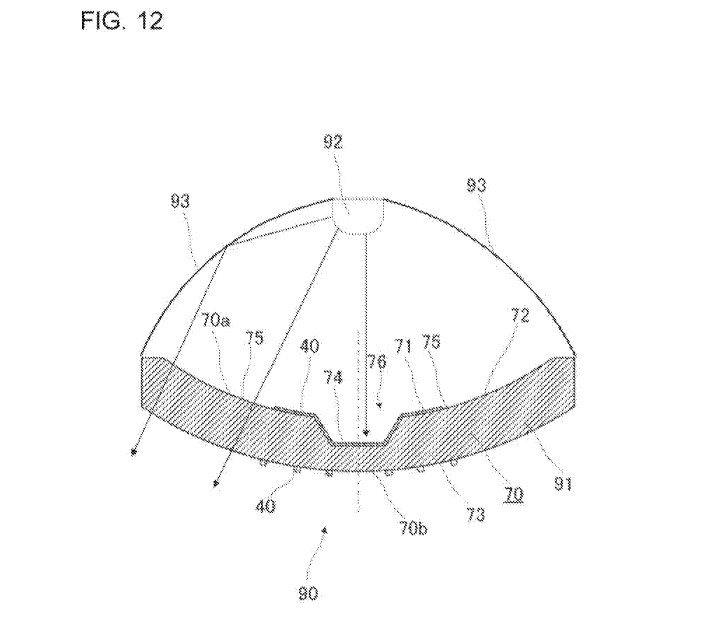

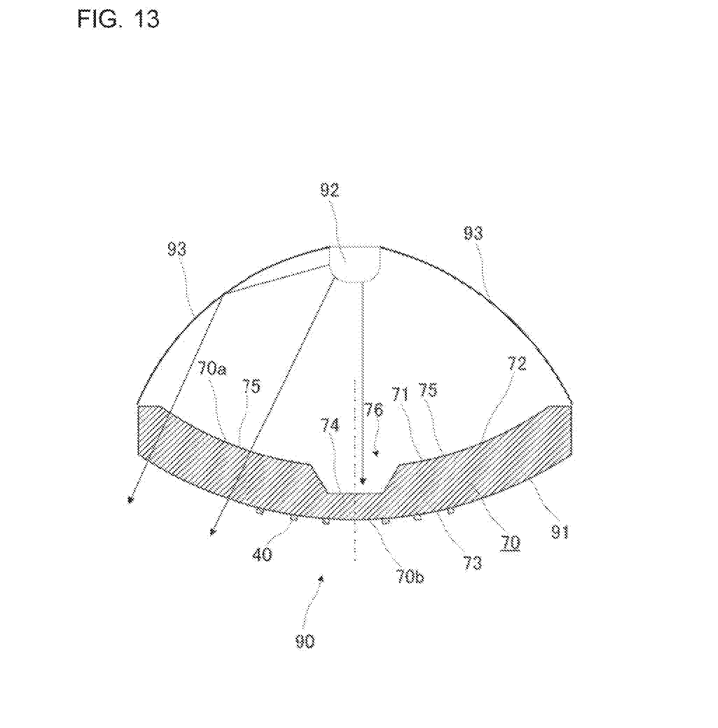

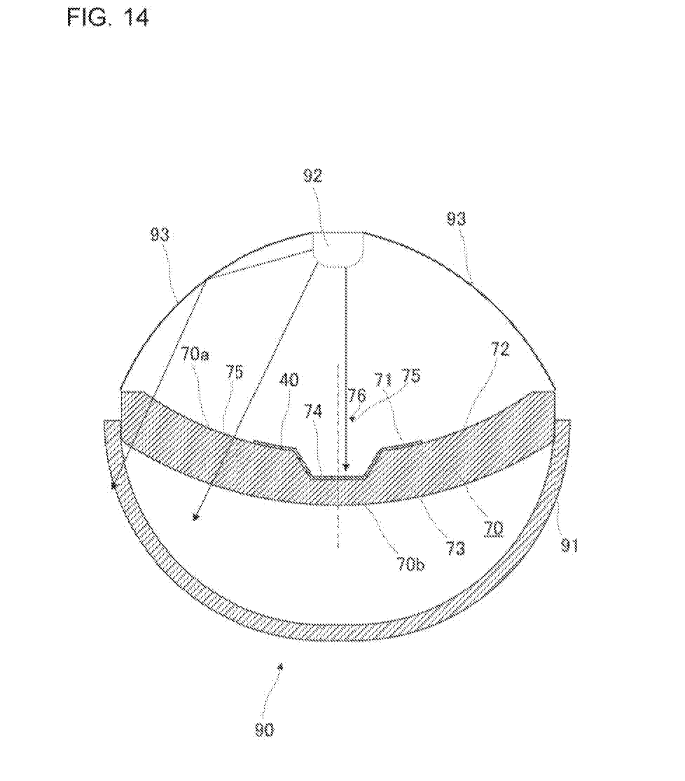

FIGS. 12 to 14 show modifications of the printed matter 70 shown in FIG. 11. FIG. 12 shows a printed matter 70 in which the print image region 40 is disposed not only on the one surface 70a, disposed at a position close to the light source 92, but also on the other surface 70b. FIG. 13 shows a printed matter 70 in which the print image region 40 is disposed only on the other surface 70b. Even when the arrangement of the print image region 40 is changed as shown in FIGS. 12 and 13, it is possible to use the printed matter 70 for adjusting the amount of light transmission or for causing a pattern to appear. FIG. 14 shows the lighting equipment 90 in which the illumination cover 91 is provided to the outside of the printed matter 70 and, instead of using the printed matter 70 as an external cover, the printed matter 70 is used to adjust the amount of light transmission in the lighting equipment 90 or is used to cause a pattern to appear. In FIGS. 12 to 14, the shape of the printed matter 70 and the shape of the illumination cover 91 may be suitably changed.

(Modification of ink 41)

The printing region 71 is formed by assemblies of the inks 41 in a dot shape as in the case of the printing regions 71a, 71b, and 71c shown in FIG. 4, and the amount of light to be transmitted is controlled by changing a ratio between the area of the first portion 42, in which the ink 41 is arranged, and the area of the second portion 43, in which no ink 41 is arranged and the surface of the base body 73 is directly exposed. However, the amount of light to be transmitted is not necessarily controlled by changing the arrangement density of the ink 41, but may also be controlled by adjusting the thickness of the ink 41 itself.

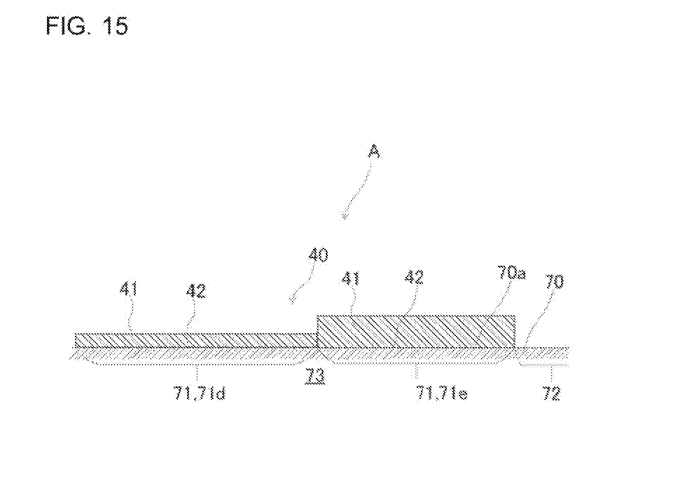

FIG. 15 is an enlarged view showing one example of the portion A shown in FIG. 1. The amount of light to be transmitted can also be controlled by changing the thickness of the ink 41. A printing region 71e shown in FIG. 15 is formed to have a thickness substantially two times as large as the thickness of the printing region 71d. In the case where the printing regions 71d and 71e are formed by the inks 41 having the same ingredients, the printing region 71d has a larger amount of light transmission than the printing region 71e. The ink 41 is obtained by mixing pigment and resin with liquid, such as solvent, for example, and when the resin is cured by drying or by ultraviolet light, the ink 41 is fixed to the surface 70a of the printed matter 70. When the proportion of pigment contained in the ink 41 is increased, the amount of light transmission in the printing regions 71d and 71e is reduced. The amount of light transmission can also be reduced by increasing the thickness of the ink 41 as in the case of the printing region 71e. In the case where the ink 41 is transferred by the printing pad 10, there is a limitation on the thickness of the ink 41 that can be formed with one transfer and hence, the printing region 71e may be formed with a plurality of transfers. That is, the printing region 71e may be formed by the ink 41 having a plurality of layers.

For example, assuming the printing region 71e shown in FIG. 15 as the first printing region and the printing region 71d as the second printing region, the first printing region has a larger thickness of the ink 41 than the second printing region. Therefore, the first printing region has a smaller amount of light transmission than the second printing region.

The plurality of print image regions 40 may be formed by inks 41 having different mixing proportions of pigment and resin. That is, the printing regions 71d and 71e shown in FIG. 15 are formed to have the same thickness, and the printing regions 71d and 71e are formed by using the inks 41 having different mixing proportions of pigment and resin, so that the amounts of light transmission can be adjusted.

For example, assume the case where the printing regions 71d and 71e shown in FIG. 15 have the same thickness, and the inks 41 used for forming the printing regions 71d and 71e contain the same kinds of pigment and resin. In such a case, the printing region 71e, being the first printing region, has a higher content of pigment than the printing region 71d, being the second printing region. Therefore, the first printing region has a smaller amount of light transmission than the second printing region.

By changing the arrangement density of the ink 41, the thickness of the ink 41, and ingredients of the ink 41, it is possible to control the amount of light transmission in each of the plurality of print image regions 40, and it is also possible to control color that is visually perceived when the light transmits through the print image region 40. The color that can be visually perceived when light transmits through the print image region 40 can be adjusted mainly by changing the kind of pigment and the color of a resin contained in the ink 41.

In the printed matter 70 according to Embodiment 1, the plurality of print image regions 40 can be formed on the surface 70a and hence, the inks 41 of different colors may be used for the plurality of respective print image regions 40. Alternatively, the plurality of respective printing regions 71 included in one print image region 40 may be formed by inks 41 having different colors.

Assume the case where the first printing region, having a relatively small amount of light transmission, and the second printing region, having a relatively large amount of light transmission, are provided by changing the thicknesses of the inks 41 and by changing the proportions of pigment and resin contained in the inks 41. Even in such a case, in forming the whole image by combining two adjacent print image regions 40, the second printing regions of the two print image regions 40 may be caused to overlap with each other. Such a configuration allows the whole image to be formed with a uniform amount of light transmission throughout the entire region.

For example, in the lighting equipment 90 shown in FIGS. 11 to 14, when the print image region 40 is provided at a plurality of positions or when the print image region 40 is formed by combining a plurality of print image regions 40, it is possible to change the colors of the inks 41 used for the plurality of print image regions 40. For example, assume the case where the color of the base body 73 is colored transparent, for example, red transparent. In such a case, in the case where the light source 92 is not in a turned-on state, basically, red of the base body 73 can be visually perceived as it is when the printed matter 70 is viewed from the surface 70b side. However, when the light source 92 is in a turned-on state, light that transmits through both the print image region 40 and the base body 73 can be seen. Accordingly, the printed matter 70 can also be formed such that different colors can be visually perceived. Alternatively, in the case where the color of the base body 73 is colorless transparent, the colors of the plurality of print image regions 40 can be visually perceived and hence, the printed matter 70 is visually perceived as the illumination cover 91 having regions having a plurality of colors. Such a configuration allows an optical component that is conventionally molded by using resin materials of two colors to be made of a material of one color. Therefore, a component that requires molding with a large number of steps, such as two-color molding, can be formed as an integral body, and regions of a plurality of colors can be provided by performing printing and hence, the component can be inexpensively produced with a small number of steps.

The present disclosure has been described heretofore based on Embodiment. However, the present disclosure is not limited to only the configurations according to Embodiment described above. Particularly, the combination of constitutional elements is not limited to the combination in Embodiment, and may be suitably changed. Further, it is also noted that various modifications, applications, and utilizations made by those who are skilled in the art when necessary also fall within the gist (technical scope) of the present disclosure.

### Reference Signs List

1: inner layer, 2: outer layer, 3: protective film layer, 4: printing surface, 5: base, 6: top portion, 7: support part, 10: printing pad, 11: vertically moving device, 12: horizontally moving device, 13: flat surface, 20: controller, 20a: arithmetic unit, 20b: storage device, 40: print image region, 41: ink, 42: first portion, 43: second portion, 50: printing original plate, 51: placement surface, 60: cleaning device, 61: activation device, 62: air blowing device, 63: ink placement device, 64: roller, 66: blower, 66A: blower, 68: temperature sensor, 70: printed matter, 70a: surface, 70b: surface, 71: printing region, 71a: printing region, 71b: printing region, 71c: printing region, 71d: printing region, 71e: printing region, 72: non-printing region, 73: base body, 74: recessed portion, 75: surface, 76: three-dimensional surface structure, 80: ultraviolet light irradiation device, 85: printing original plate stage, 86: surface treatment stage, 87: printing stage, 89: jig, 90: lighting equipment, 91: illumination cover, 92: light source, 93: reflection surface, 100: printing apparatus.

1. A printed matter manufacturing method of manufacturing printed matter, wherein
the printed matter comprises:
a base body made of a material that allows transmission of light, a visible surface of the base body having a three-dimensional surface structure having a depth;
a print image region provided on at least one surface of the base body, the print image region being a region in which ink is placed; and
a non-printing region provided on the one surface, the non-printing region being a region in which no ink is placed, wherein
the print image region is provided in an area including the three-dimensional surface structure formed on the one surface,
the print image region has a smaller amount of light transmitted than the non-printing region, and
the three-dimensional surface structure comprises one or more recesses in the base body,
the method comprising a printing process in which a printing pad is pushed against at least the one surface of the base body to transfer the ink placed on a printing surface of the printing pad to the one surface, thus forming, at least at a portion of the one surface, the print image region to which the ink is transferred, wherein
the printing process includes
pushing the printing surface against a printing original plate on which the ink is placed,
moving the printing pad, in which the ink is transferred to the printing surface, to an area above the base body, and
pushing the printing surface of the printing pad to cause the printing surface to deform in such a way as to conform to the three-dimensional surface structure.

2. The printed matter manufacturing method of claim 1, wherein
the printing process is performed a plurality of times to form a plurality of printing regions on the one surface of the base body,
each of the plurality of printing regions includes a first printing region and a second printing region,
the first printing region has a higher arrangement density of the ink than the second printing region, and
second printing regions of two adjacent printing regions of the plurality of printing regions are disposed in such a way as to overlap with each other.

3. The printed matter manufacturing method of claim 1, wherein
in the printing process,
the second printing regions of the two adjacent printing regions are disposed in such a way as to include, in cross section parallel to a direction along which the printing pad is pushed, a portion of the three-dimensional surface structure that has a tangent being perpendicular to the direction along which the printing pad is pushed, the portion being within a region with which the printing pad is brought into contact.
